(19) United States
(12) Patent Application Publication
(10) Pub. No.: US 2008/0154849 A1
(43) Pub. Date: Jun. 26, 2008

(54) METHOD, GRAPHICAL USER INTERFACE, AND COMPUTER PROGRAM PRODUCT FOR GROUPING SEARCH RESULTS

(75) Inventor: Christopher K. Karstens, Apex, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/614,137

(22) Filed: Dec. 21, 2006

(51) Int. Cl. G06F 17/30

(52) U.S. Cl. 707/3; 707/E17.001

(57) ABSTRACT

Search results are organized by grouping child search results with associated parent search terms. Search results are retrieved from a search of an electronic database based on at least one parent search term. At least one child search result in generated that is associated with the parent search term. The generated child search result is grouped with the associated parent search term, and the grouping of the generated child search result with the associated parent search term is presented in a list. Child search results are generated and grouped with associated parent search terms, and the groupings of the generated child results with the associated parent search terms are presented for successively retrieved search results based on parent search terms. Each grouping of child search results with associated parent search terms remains on the list with each successive search.

### BACKGROUND

The present invention relates generally to grouping search results, in particular to grouping parent search terms with child search results.

The increase in computer usage in recent years has made information increasingly accessible. The availability of information has increased exponentially with the linking of computers via local area networks and wide area networks, such as the Internet. As the amount of available information increases, management and retrieval of the information have become increasingly important and complex. An important element in managing and retrieving such information is indexing.

Indexing involves cataloging information in an efficient and coherent manner so that it can be easily accessed. Traditional indexing and retrieval schemes are ill equipped to accommodate the creation of useful indexes. In particular, techniques are needed for effectively associating “child” results with given “parent” search terms.

As an example, when a Google search is performed, and a link is selected based on the search results returned, a user is unable to tell that the selected link is related to the initial search term. When the user elinks on the selected link, this may result in another window being opened, with other links. When the user then clicks on links within that other window, it becomes even more difficult to recall that the links within the other window are related back to the original search terms. Even worse, if the user is presented with several links in response to the initial key word search, clicks on several of those links to open various windows, and then clicks on links within those various windows, it is very difficult to determine what links relate to the initial search terms. So, if the user returns to the original search result list and clicks on another link to open another window and then clicks on a link within that window, there are now several additional windows open with no easy way to indicate how they are related.

This problem is not limited to Internet searches but is also prevalent in other types of electronic database searches, such as operating system searches. For example, if folders in an operating system are searched using a keyword, and a file is selected from a folder found based on the search, there is no way to indicate to the user that the file is related to the keyword. This becomes a problem as more and more searches are conducted and more folders and files are selected.

### SUMMARY

According to exemplary embodiments, search results are organized by grouping child search results with associated parent search terms. Search results are retrieved from a search of an electronic database based on at least one parent search term. At least one child search result is generated that is associated with the parent search term. The generated child search result is grouped with the associated parent search term, and the grouping of the generated child search result with the associated parent search term is presented in a list. Child search results are generated and grouped with associated parent search terms, and the groupings of the generated child search results with the associated parent search terms are presented for successively retrieved search results based on parent search terms. Each grouping of child search results with associated parent search terms remains on the list with each successive search.

### BRIEF DESCRIPTION OF THE DRAWINGS

Referring to the exemplary drawings wherein like elements are numbered alike in the several Figures:

FIG. 1 depicts an exemplary graphical user interface for grouping search results according to exemplary embodiments.

FIG. 2 illustrates an exemplary method for grouping search results according to exemplary embodiments.

FIG. 3 illustrates an exemplary system for grouping search results according to exemplary embodiments.

### DETAILED DESCRIPTION

According to an exemplary embodiment, a graphical user interface (GUI) is provided for grouping child search results with parent search terms for easy navigation and organization. The GUI becomes more powerful as the number of searches and results generated increases.

According to an exemplary embodiment, a grouping control, like a tabbed browser, is provided with support for children links and/or windows to that control. Child names may include filenames, web page titles, search information enhanced titles, etc. Children may be populated via actual links taken/selected.

As an alternative, children may be populated by search information enhanced window names. For example, in a web browser environment, when a user opens a web page, the title of the web page is displayed on the title bar of the browser window. The title may be misleading or incorrect. According to an exemplary embodiment, the title provided by the web page code may be overridden or supplemented with search engine and search terms. So, for example, instead of having a child with a title of “Electronics”, this title may be supplemented with search engine and search terms as “[Google: iPOD] Electronics]”. This provides the user with a much better idea of what the child link/window contains before it is selected. So, when the user executes a search against a search engine, the user knows what text will be pre-pended to any spawned children windows.

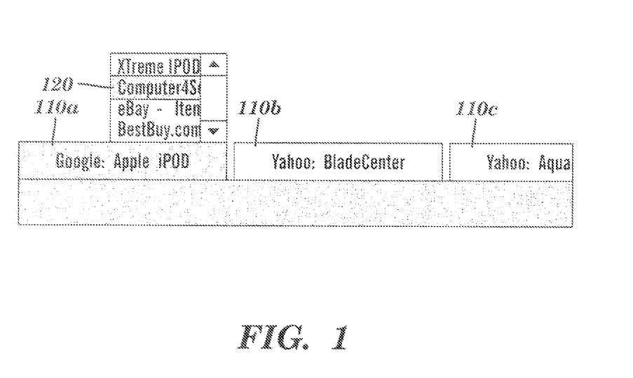

FIG. 1 illustrates a portion of a graphical user interface showing a list of child search results grouped with associated parent search terms in a web browser environment according to an exemplary embodiment. In the graphic shown, parent search terms (keywords) are encapsulated in tabs 110a, 110b, and 110c. It should be appreciated, however, that search terms do not have to be presented using tabs but they can be presented in any manner suitable for a user.

When a child link/result is viewed, it is added to the children of the parent group control for easy recall. Children in a list may represent link history and/or active resident “files/results/web pages/etc.”. Children may persist forever until a parent search term is closed, e.g., until a tab or other representation of a parent search term is closed. Alternatively, a child may drop off the list when a child file/webpage/result view is closed.

Referring again to FIG. 1, three tabs 110a, 110b, and 110c appear corresponding to three parent search terms. When the focus is set on the parent “Google: Apple iPOD” tab 110a, children appear in a “looping” listbox 120. Selecting a child, such as “Computer4Su” causes that child resident web page (“Computer4Sure”) to be displayed in the web browser body. In one embodiment, placing a mouse cursor over a particular child will cause a hover-over-help window to appear with the full text title of the child. For example, for child “Computer4Su”, the hover-over-help window may show “Computer4Sure Headquaters”. According to one embodiment, if the parent search terms are updated, the previous children are deleted. Tabs and children can be sorted, e.g., alphabetically, for enhanced management.

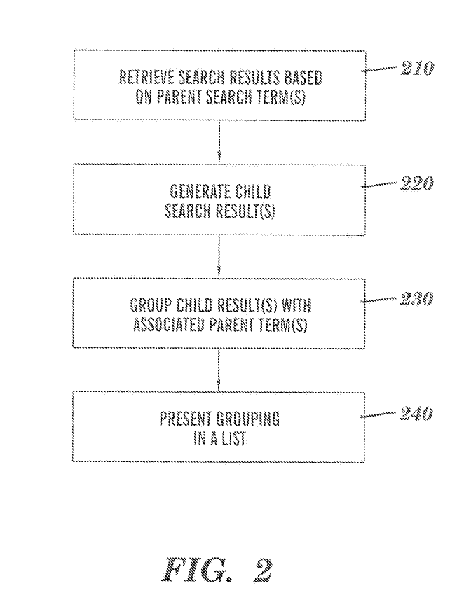

FIG. 2 illustrates a method for grouping child results with parent search terms. Referring to FIG. 2, the method begins at step 210 at which search results are retrieved from a search of an electronic database, the search based on at least one parent search term. At step 220, at least one child search result associated with the parent search term is generated. At step 230, the generated child search result is grouped with the associated parent search term. At step 240, the grouping of the generated child search result with the associated parent search term is presented in a list. The steps of generating child search results associated with parent search terms, grouping the generated child search results, and presenting the grouping of the generated child search results are performed for successively retrieved search results based on parent search terms. Each grouping of child search results with associated parent search terms remains on the list with each successive search.

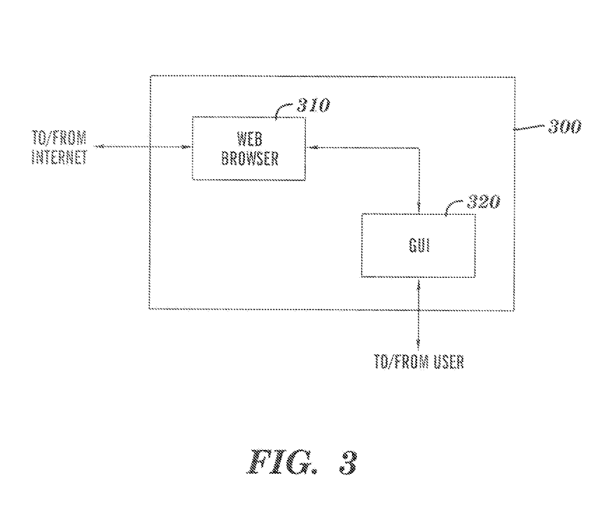

FIG. 3 illustrates an exemplary system for grouping search results according to exemplary embodiments. According to an exemplary embodiment, the system may include a computer 300 with a graphical user interface (GUI) 320. The GUI 320 may be incorporated as part of the computer 300 as shown or may be attached as a separate device in communication with the computer via an interface. The computer also includes a computer program or application, such as a web browser 310, for searching an electronic database, e.g., the Internet, and grouping search results.

According to one embodiment, a search is initiated by a user inputting one or more parent search terms via the GUI 320. The web browser 310 conducts the search via the Internet, and the search results are returned to the GUI 320. Child results are populated based on the parent search terms. According to one embodiment, if child results spawn their own child results, all descendants of the original parent search terms may be presented via the GUI 320 as associated with the original parent search terms. According to an alternative embodiment, by placing a mouse cursor over a child with its own children, an additional window may be generated depicting those children. For example, a user may click on a child in a list of search results, and this, in turn, may cause a plurality of child links to be presented in a new window.

According to an exemplary embodiment, the child results are grouped with the parent search terms by the web browser 310, and the grouping is presented in a list via the GUI 320. The child results grouped with the associated parent search terms may be stored in memory for later recall and presentation to the GUI 320.

Although not shown in the interest of simplicity of illustration, it should be appreciated that the computer 300 may include other elements, e.g., a microprocessor, various software applications, etc. Also, the computer 300 is not limited to a personal computer or laptop computer but may include any device capable of conducting electronic database searches, grouping search results as described above, and presenting the grouped results to a user. Furthermore, the computer may include another application for searching an electronic database other than the internet, e.g., a data management system for searching files resident within the computer memory.

As described above, exemplary embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for grouping search results, comprising:
retrieving search results from a search of an electronic database based on at least one parent search term;
generating at least one child search result associated with the parent search term;
grouping the generated child search result with the associated parent search term;
presenting the grouping of the generated child search result with the associated parent search term in a list; and
performing the steps of generating child search results associated with parent search terms, grouping the generated child search results, and presenting the grouping of the generated child search results for successively retrieved search results based on parent search terms, wherein each grouping of child search results with associated parent search terms remains on the list with each successive search.

2. The method of claim 1, wherein the list is presented as a tabbed browser showing links or windows to child search results.

3. The method of claim 1, wherein the search is an Internet search, and the child search result is generated base on an actual link selected.

4. The method of claim 1, wherein the child search result is generated based on an enhanced window name.

5. The method of claim 1, wherein the child search result has a name that includes at least one of: a file name, a web page title, and search information enhanced titles.

6. The method of claim 1, wherein the child search result exists in the list associated with a parent search term until the parent search term is closed.

7. The method of claim 1, wherein the child search result exists in the list associated with a parent search term until the child search result is closed.

8. A system for grouping search results, comprising:
an application for retrieving search results from a search of an electronic database based on at least one parent search term, generating at least one child search result associated with the parent search term, and grouping the generated child search result with the associated parent search term; and
a user interface for presenting the grouping of the generated child search result with the associated parent search term in a list, wherein grouped child results associated with parent search terms are presented in the list for successively retrieved search results based on parent search terms, and wherein each grouping of child search results with associated parent search terms remains on the list with each successive search.

9. The system of claim 8, wherein the list is presented as a tabbed browser showing links or windows to child search results.

10. The system of claim 8, wherein the search is an Internet search, and the child search result is generated based on an actual link selected.

11. The system of claim 8, wherein the child search result is generated based on an enhanced window name.

12. The system of claim 8, wherein the child search result has a name that includes at least one of: a file name, a web page title, and search information enhanced titles.

13. The system of claim 8, wherein the child search result exists in the list associated with a parent search term until the parent search term is closed.

14. The system of claim 8, wherein the child search result exists in the list associated with a parent search term until the child search result is closed.

15. A computer program product for conducting a search of an electronic database, comprising a computer usable medium having a computer readable program, wherein the computer readable program, when executed on a computer, causes the computer to:
retrieve search results from a search of an electronic database, the search based on at least one parent search term;
generate at least one child search result associated with the parent search term;
group the generated child search result with the associated parent search term;
present the grouping of the generated child search result with the associated parent search term in a list; and
cause the computer to generate child search results associated with parent search terms, group the generated child search results, and present the grouping of the generated child search results for successively retrieved search results based on parent search terms, wherein each grouping of child search results with associated parent search terms remains on the list with each successive search.

16. The computer program product of claim 15, wherein the list is presented as a tabbed browser showing links or windows to child search results.

17. The computer program product of claim 15, wherein the search is an Internet search, and the child search result is generated based on an actual link selected.

18. The computer program product of claim 15, wherein the child search result is generated based on an enhanced window.

19. The computer program product of claim 15, wherein the child search result has a name that includes at least one of: a file name, a web page title, and search information enhanced titles.

20. The computer program product of claim 15, wherein the child search result exists in the list associated with a parent search term until the parent search term is closed or until the child search result is closed.
